(19) United States
(12) Patent Application Publication
(10) Pub. No.: US 2004/0250647 A1
(43) Pub. Date: Dec. 16, 2004

(54) Head lock ring device of bicycle

(76) Inventor: Wen-Hwa Lin, Taipei (TW)

Correspondence Address: Wen-Hwa Lin, 235 Chung-Ho, Box 8-24, Taipei, TW

(21) Appl. No.: 10/457,713

(22) Filed: Jun. 10, 2003

(51) Int. Cl. B62K 21/14

(52) U.S. Cl. 74/551.2

(57) ABSTRACT

The head lock ring device comprises a seat being installed at one end of an outer sleeve for locating the bearing; an upper cover covering the seat for firmly securing the bearing; an upper end of the upper cover being formed with a retaining surface for being engaged with an spanner; and a seal cover engaged to one end of the upper cover; the seal cover having an enclosing ring and a driving end; the enclosing ring exactly enclosing the retaining surface; the driving end being engaged with a spanner; an inner wall of the seal cover being formed with an inner thread; the inner thread being engaged to the respective thread of the front fork tube so that the seal cover being aligned to the center of the upper cover and the front fork tube; thus the head lock ring can be assembled to the front fork tube easily.

### FIELD OF THE INVENTION

The present invention relates to bicycles, and particularly to a head lock ring device of a bicycle which can be assembled to a front fork tube easily and conveniently.

### BACKGROUND OF THE INVENTION

A head lock ring is assembled to the front fork tube of a bicycle so that the head of the bicycle can swing as desired. In general, a lower seat of the head lock ring installed on the front fork tube rests against an upper edge of the bicycle frame. The cover at another end is firmly secured to a handlebar stem. Meanwhile, the inner edge of the cover is installed with a tapered buckle. The tapered buckle is engaged to the front fork tube so that that the head lock ring is fixed to the front fork tube. Although use of this head lock ring has no great defect, and moreover, in assembly, a succeeding action of secondary adjustment is necessary. Moreover, if it is desired to pull the tapered buckle out of the front fork tube, it is often that they are deadly locked. Thereby, the update of the head lock ring is inconvenient. Further, in general, the water-proof and dust-proof ability of a head lock ring is not preferred this is because the end of the upper cover resisting against the head lock ring can not be sealed completely. Thereby, dust and rain will drain into the head lock ring. For a long time, the head lock ring and other related element will rust so as to reduce the lifetime and have a bad appearance.

### SUMMARY OF THE INVENTION

Accordingly, the primary object of the present invention is to provide a head lock ring device. The head lock ring device comprises a head lock ring. The head lock ring comprises a seat being installed at one end of an outer sleeve for locating the bearing; an upper cover covering the seat for firmly securing the bearing; an upper end of the upper cover being formed with a retaining surface for being engaged with an spanner; and a seal cover engaged to one end of the upper cover; the seal cover having an enclosing ring and a driving end; the enclosing ring exactly enclosing the retaining surface; the driving end being engaged with a spanner; an inner wall of the seal cover being formed with an inner thread; the inner thread being engaged to the respective thread of the front fork tube so that the seal cover being aligned to the center of the upper cover and the front fork tube; thus the head lock ring can be assembled to the front fork tube easily.

The various objects and advantages of the present invention will be more readily understood from the following detailed description when read in conjunction with the appended drawing.

### BRIEF DESCRIPTION OF THE DRAWINGS

FIG. 1 is a schematic view of the present invention.

FIG. 2 is an exploded schematic view Of the present invention.

FIG. 3 is a partial schematic view of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined it the appended claims.

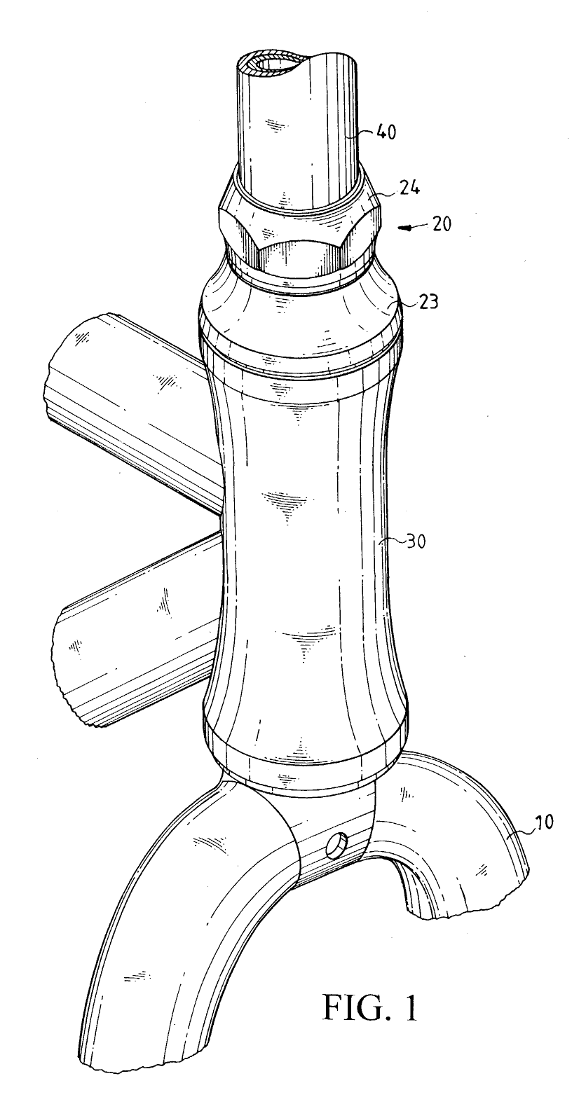

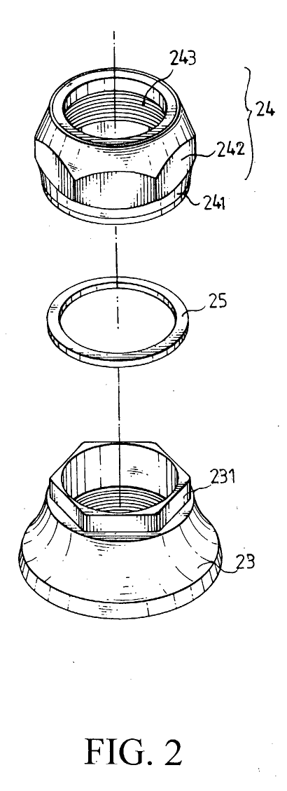

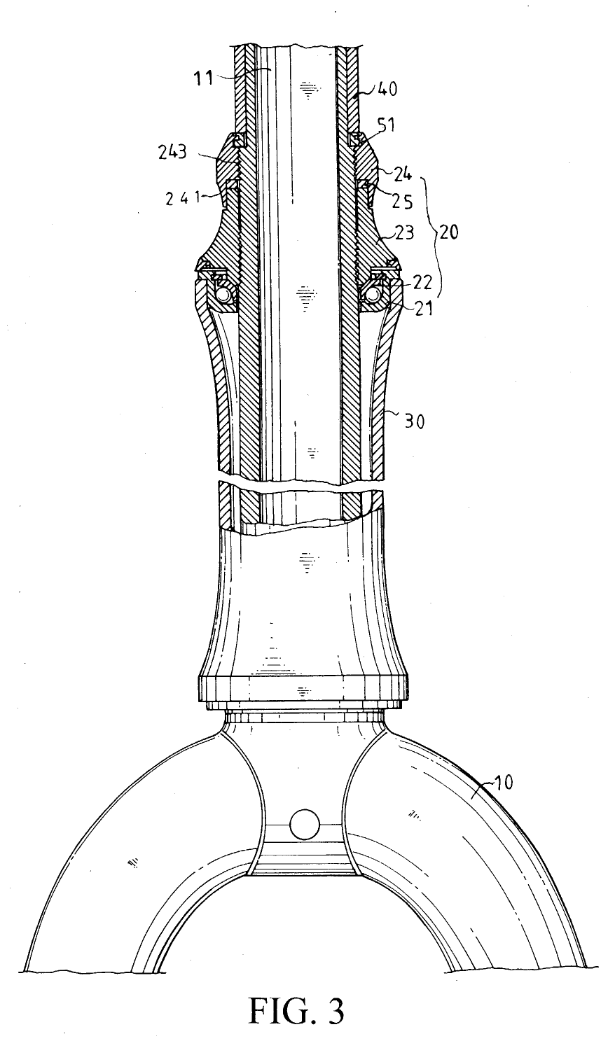

Referring to FIGS. 1 to 3, the head lock ring device of the present invention includes a front fork tube 11 installed on the front fork 10, a head lock ring 20 installed on the front fork tube 11, and an sleeve tube 30 for firmly locating the head lock ring 20 and handlebar stem 40.

The head lock ring 20 is formed by a seat 21, a bearing 22, an upper cover 23, and a seal cover 24.

The seat 21 is installed at one end of an outer sleeve 30 and has an L shape for locating the bearing 22.

The bearing 22 is formed by a plurality of steel balls which are capable of rolling on the seat 21.

The upper cover 23 covers the seat 21 for firmly securing the bearing 22. An upper end of the upper cover 23 is formed with a retaining surface 231 for being engaged with a spanner.

The seal cover 24 is a polygonal block and is engaged to one end of the upper cover 23. The seal cover 24 has an enclosing ring 241 and a driving end 242. The enclosing ring 241 is slightly larger than the retaining surface 231 of the upper cover 23 to exactly enclose the retaining surface 231. A washer 25 is installed between the upper cover 23 and the seal cover 24. The driving end 242 serves for engaging a spanner. A water-proof rubber ring 51 can be installed in the inner edge of the driving end 242. An inner wall of the seal cover 24 is formed with an inner thread 243. The inner thread 243 can be engaged to the respective thread of the front fork tube 11 so that the seal cover 24 is aligned to the center of the upper cover 23 and the front fork tube 11.

Thereby, by the seal cover 24 to enclose the retaining surface 231 of the upper cover 23, the head lock ring 20 has a preferred effect of water-proof and dust-proof. Thereby, it has a beautiful outlook. Moreover, by the seal cover 24 is aligned to the center of the front fork tube 11 and the upper cover 23, the adjusting time can be simplified. Therefore, assembly of the head lock ring 20, is more precise, convenient and has a steady structure.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A head lock ring device comprising:
a head lock ring including
a seat being installed at one end of an outer sleeve for locating the bearing;
an upper cover covering the seat for firmly securing the bearing; an upper end of the upper cover being formed with a retaining surface for being engaged with an spanner; and
a seal cover engaged to one end of the upper cover; the seal cover having an enclosing ring and a driving end; the enclosing ring exactly enclosing the retaining surface; the driving end being engaged with a spanner; an inner wall of the seal cover being formed with an inner thread; the inner thread being engaged to the respective thread of the front fork tube so that the seal cover being aligned to the center of the upper cover and the front fork tube; thus the head lock ring can be assembled to the front fork tube easily.

2. The head lock ring device as claimed in claim 1, wherein a water-proof rubber ring is installed in the inner edge of the driving end.
